(19) United States
(12) Patent Application Publication
(10) Pub. No.: US 2022/0255217 A1
(43) Pub. Date: Aug. 11, 2022

(54) ANTENNA ANGLE ADJUSTMENT DEVICE AND AN ANTENNA

(71) Applicant: CommScope Technologies LLC, Hickory, NC (US)

(72) Inventors: ZiCheng Su, Suzhou (CN); Yali Chen, Suzhou (CN)

(21) Appl. No.: 17/574,775

(22) Filed: Jan. 13, 2022

(30) Foreign Application Priority Data
Feb. 8, 2021 (CN) 202110170454.3

(51) Int. Cl. H01Q 3/08; H01Q 3/04

(52) U.S. Cl. CPC H01Q 3/08; H01Q 3/04

(57) ABSTRACT

The present disclosure relates to an antenna angle adjustment device, and the angle adjustment device includes a drive member (10) and a driven member (4). The drive member is supported rotatably around a first rotation axis (X1) and can be manipulated and fixed. The driven member is supported rotatably around a second rotation axis (X2), and the angular position of the driven member is related to the angular position of the antenna. The drive member has an engagement point, and the driven member has a concave curved portion. The engagement point extends into the curved portion and engages the curved portion so that the rotation of the drive member around the first rotation axis can cause the rotation of the driven member around the second rotation axis. The present disclosure further relates to an antenna with the angle adjustment device. The angle of the antenna can be appropriately adjusted by the angle adjustment device.

### RELATED APPLICATION

The present application claims priority from and the benefit of Chinese Patent Application No. 202110170454.3, filed Feb. 8, 2021, the disclosure of which is hereby incorporated herein by reference in full.

### FIELD OF THE INVENTION

The present disclosure relates to the field of communication technology, and in particular to an antenna angle adjustment device and an antenna with the angle adjustment device.

### BACKGROUND OF THE INVENTION

Antennas are widely used in radio communication technology, and they are configured to receive and/or transmit radio signals. An antenna may be, for example, a conventional large-sized base station antenna, a small cell antenna or a microwave antenna. Typically, a microwave antenna can work in a wavelength range of meter waves, centimeter waves, or millimeter waves. The orientation of the antenna, such as pitch angle, azimuth angle, and/or polarization angle, may be an important parameter that affects the working performance of the antenna. An orth-mode transducer (OMT) component may be provided in some known microwave antennas, wherein the polarization direction of the microwave antenna can be changed by rotating the OMT component. For comparison, please refer to the publication document WO2019191917A1. In the prior art, it is often difficult and imprecise to manually rotate the OMT component.

### SUMMARY OF THE INVENTION

The objective of the present disclosure is to provide an antenna angle adjustment device and an antenna with the angle adjustment device, wherein the angle of the antenna can be easily adjusted with simple measures by the angle adjustment device.

A first aspect of the present disclosure provides an antenna angle adjustment device, wherein the angle adjustment device includes:

a drive member, which is supported rotatably around a first rotation axis and can be manipulated and fixed; and

a driven member, which is supported rotatably around a second rotation axis and has an angular position related to that of the antenna;

wherein, the drive member has a engagement point, the driven member has a concave curved portion, the engagement point extends into the curved portion and is joined with the curved portion so that a rotation of the drive member around the first rotation axis can cause a rotation of the driven member around the second rotation axis.

B using the angle adjustment device, it is possible to adjust, especially finely adjust the angle of the antenna, such as the polarization direction of a microwave antenna, when manipulating the drive member.

The angle adjustment device can be applied to a base station antenna such as a small cell antenna. The angle adjustment device can be applied to a microwave antenna. The angle of the antenna to be adjusted may involve, for example, at least one of a pitch angle, an azimuth angle, and a polarization angle.

In some embodiments, the engagement point and the curved portion may be in a point contact, a linear contact, or a plane contact.

In some embodiments, the drive member may have a supporting hole, and the drive member may be rotatably supported on a rotation shaft by the supporting hole.

In some embodiments, the angle adjustment device may include a bolt which passes through the supporting hole, and the driven member is supported on an unthreaded section of a shank of the bolt.

In some embodiments, the bolt may be configured to fasten the drive member.

Therefore, the same component may be used not only as the rotation shaft of the drive member but also as a fastening member of the drive member.

In some alternative embodiments, the rotation shaft and the fastening member may be two separate members.

In some embodiments, the first rotation axis and the second rotation axis may be parallel to each other, or form a small angle with each other, for example, an included angle of 30° or less.

In some embodiments, the drive member may have a finger-shaped part, and the finger-shaped part may have an arcuate surface, or the finger-shaped part may have a roller on its free end, and the arcuate surface or the roller may serve as the engagement point to be joined with the curved portion.

In some embodiments, the finger-shaped part may be formed axisymmetrically in a plane perpendicular to the first rotation axis.

In some embodiments, the drive member may have a tool engagement point configured to be joined with a tool for manipulating the drive member. The tool engagement point may be configured, for example, to be joined with a wrench, or may be configured to be a hole, for example, a polygonal hole, for the insertion of an operating lever, and the operating lever may have a cross-sectional shape corresponding to that of the hole.

In some embodiments, the driven member may have a flange plate, and the flange plate may have the curved portion.

In some embodiments, the flange plate may extend in a plane perpendicular to the second rotation axis.

In some embodiments, the curved portion may be formed axisymmetrically in a plane perpendicular to the second rotation axis.

In some embodiments, the driven member may be an OMT component of the microwave antenna, or a component kinematically coupled with an OMT component.

In some embodiments, the angle adjustment device may be configured to finely adjust the polarization direction of the microwave antenna.

In some embodiments, the angle adjustment device may be configured to finely adjust the polarization direction of the microwave antenna within a range of±5.

In some embodiments, the drive member and the driven member may have a constant transmission ratio preferably greater than 1, particularly 3 or greater, preferably 5 or greater, for example, 7 or greater.

In some embodiments, the transmission ratio may be 20 or less, particularly 18 or less, preferably 15 or less, for example, 12 or less.

A second aspect of the present disclosure provides an antenna, which is fitted with the antenna angle adjustment device according to any one embodiment of the present disclosure.

The various technical features mentioned above, various technical features that will be mentioned below, and technical features that can be obtained from the drawings may be combined arbitrarily as long as the combined individual technical features do not conflict with each other.

### BRIEF DESCRIPTION OF THE DRAWINGS

Some non-restrictive exemplary embodiments of the present disclosure will be described below with reference to schematic drawings, in which:

FIG. 1 is a perspective view of an antenna with an angle adjustment device in an installed state according to an embodiment of the present disclosure.

FIG. 2 is a perspective view of a drive member of the angle adjustment device of FIG. 1.

FIG. 3 is a perspective view of a drive member of angle adjustment device of FIG. 1 according to another embodiment.

FIG. 4 and FIG. 5 are partial schematic views of the antenna of FIG. 1 in two different adjustment states of the angle adjustment device.

### DETAILED DESCRIPTION OF SPECIFIC EMBODIMENTS

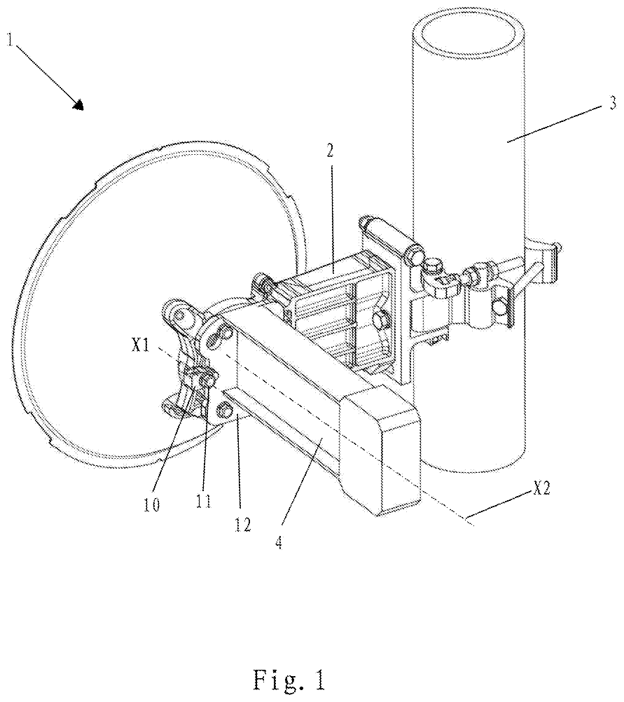

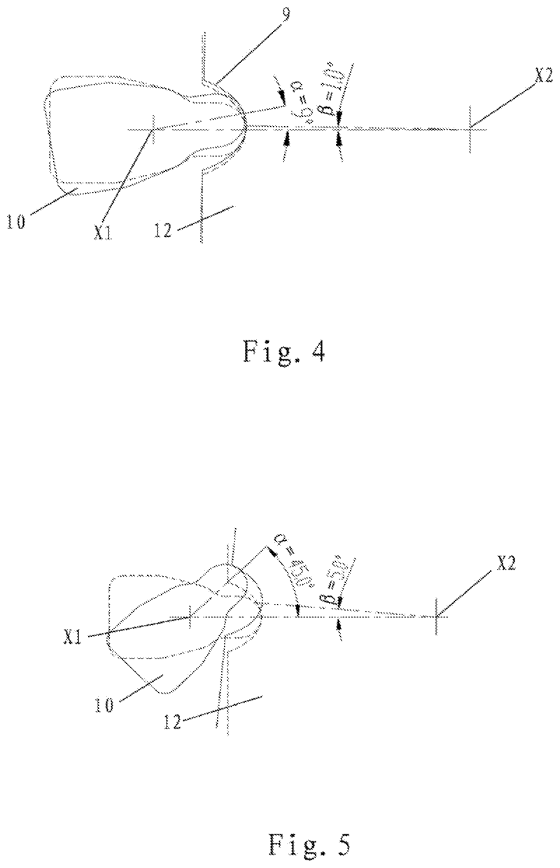

FIG. 1 is a perspective view of an antenna 1 with an angle adjustment device in an installed state according to an embodiment of the present disclosure. In the illustrated embodiment, the antenna 1 is configured as a microwave antenna which has an OMT component. The illustrated OMT component has a flange plate 12 on an end side. The flange plate 12 may also be referred as a flame plate or an interface plate. The flange plate 12 may have a concave curved portion 9 which will be described in more detail later (see FIG. 4 and FIG. 5). The OMT component can rotate around a rotation axis X2, and the angular position of the OMT component around the axis X2 is related to the polarization direction of the antenna 1. In other words, the polarization direction of the antenna 1 can be adjusted by rotating the OMT component around the rotation axis X2. The antenna 1 can be mounted on a mounting support 2, and the mounting support 2 can be fastened to a pole 3 by a clamping device. Only one section of the pole 3 is depicted in FIG. 1, and the antenna is mounted in this section. In some embodiments not shown, the antenna may also be configured as a small cell antenna. Typically, the small cell antenna may be configured as a roughly cylindrical device, which may have, for example, a circular or polygonal cross section.

The antenna 1 may have an angle adjustment device. The angle adjustment device may include a drive member 10 and a driven member 4. In the embodiment shown in FIG. 1, the driven member 4 is formed through an OMT component. In some alternative embodiments, the driven member 4 may also be a component kinematically coupled with an OMT component. The drive member 10 may be supported rotatably around a rotation axis X1 and can be manipulated and fixed. The driven member 4 may be supported rotatably around the rotation axis X2. The angular position of the driven member 4 may be related to the angular position of the antenna 1.

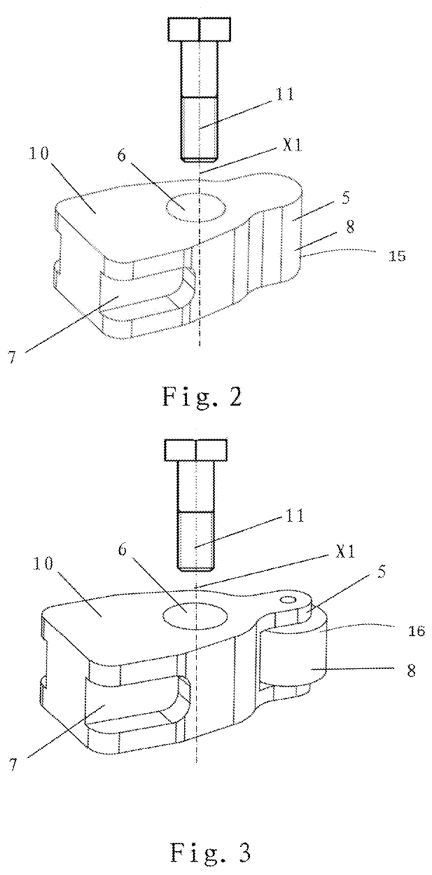

As shown in FIG. 2, the drive member 10 may have a supporting hole 6, and the central axis of the supporting hole 6 may define the rotation axis X1 of the drive member 10. A bolt 11 may pass through the supporting hole 6. The illustrated bolt 11 may use the unthreaded section of its shank as the rotation shaft of the drive member 10, and may be screwed into the threaded hole of the mounting support 2 by its threaded section. When the bolt 11 is not tightened, the drive member 10 can rotate around the unthreaded section of the bolt 11 as a rotation shaft. When the bolt 11 is tightened, the drive member 10 can be fixed. The two rotation axes X1 and X2 may be parallel to each other or form an angle with each other.

The drive member 10 may have a finger-shaped part 5. The finger-shaped part 5 may have an arcuate surface 15, which may be a static portion of the finger-shaped part 5 or may be provided by a roller or wheel 16 (see FIG. 3). The drive member 10 may engage the concave curved portion 9 to be described later of the driven member 4 by its arcuate surface 15, that is, the arcuate surface 15 serves as an engagement point 8 of the drive member 10. The rotation of the drive member 10 around the rotation axis X1 can cause the rotation of the driven member 4 around the rotation axis X2.

The drive member 10 may have a tool engagement point 7 configured to be joined with a tool, in particular a wrench, for manipulating the drive member 10. In some embodiments not shown, instead of the tool engagement point 7 for a wrench, an inner hexagonal hole may be provided in the drive member 10. An operating lever with an outer hexagonal plug may be inserted into the inner hexagonal hole. By pulling the operating lever, it is possible to manipulate the drive member 10 to make the drive member 10 rotate around the rotation axis X1.

FIG. 3 is a perspective view of the drive member 10 according to another embodiment, and the main difference from the drive member in FIG. 2 is that the aforementioned roller 16 is provided on the free end of the finger-shaped part 5; the roller 16 engages the concave curved portion 9 of the driven member 4. In other words, the roller 16 selves as the engagement point 8 of the drive member 10.

The angle adjustment device for the antenna 1 will be further described below with reference to FIG. 4 and FIG. 5. FIG. 4 and FIG. 5 are partial schematic views of the antenna 1 in FIG. 1 in two different adjustment states of the angle adjustment device, wherein the rotation axes X1 and X2 are parallel to each other and perpendicular to the plane of the drawing.

In FIG. 4, the initial position of the partially depicted flange plate 12 of the drive member 10 and the driven member 4 is depicted by broken lines, and the adjusted position of the flange plate 12 of the drive member 10 and the driven member 4 is depicted by a solid line. In FIG. 4, in the projection along the rotation axes X1 and X2, the rotation axes X1 and X2, and the junction point of the engagement point 8 of the drive member 10 and the curved portion 9 of the driven member 4 are on a straight line at the initial position. Starting from the initial position to the first adjusted position shown by the solid line in FIG. 4, the drive member 10 rotates by an angle of α=9, and the driven member 4 rotates by an angle of β=1°. Here, the drive member 10 and the driven member 4 may have a constant transmission ratio of 9.

In FIG. 5, the initial position of the partially depicted flange plate 12 of the drive member 10 and the driven member 4 is also depicted by broken lines, and the adjusted position of the flange plate 12 of the drive member 10 and the driven member 4 is depicted by a solid line. Starting from the initial position to the second adjusted position shown by the solid line in FIG. 5, the drive member 10 rotates by an angle of α=45°, and the driven member 4 rotates by an angle of β=5. Here, the drive member 10 reaches an end position of its adjustment range.

Starting from the initial position, the drive member 10 may be adjusted opposite to the situations in FIG. 4 and FIG. 5, and the drive member 10 rotates by an angle of α=−45° (and thus the driven member 4 rotates by an angle of β=−5°) from the initial position. Here, the drive member 10 reaches the other end position of its adjustment range.

Through a constant large transmission ratio between the drive number 10 and the driven member 4, the angle of the antenna 1 can be easily fine-tuned, and after fine tuning, the orientation of the antenna. 1 can be fixed by simply tightening the bolt 11.

Advantageously, as shown in FIG. 4 and FIG. 5, the finger-shaped part 5 may be formed axisymmetrically in a plane perpendicular to the rotation axis X1, and the curved portion 9 may be formed axisymmetrically in a plane perpendicular to the rotation axis X2.

It will be understood that, the terminology used herein is for the purpose of describing particular aspects only and is not intended to be limiting of the disclosure. As used herein, the singular forms “a”, “an” and, “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or”includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached,” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all example embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

1. An antenna angle adjustment device, comprising:
a drive member (10), which is supported rotatably around a first rotation axis (X1) and can be manipulated and fixed; and
a driven member (4), which is supported rotatably around a second rotation axis (X2) and has an angular position related to that of the antenna;
wherein, the drive member has an engagement point (8), the driven member has a concave curved portion (9), the engagement point extends into the curved portion and engages the curved portion so that a rotation of the drive member around the first rotation axis can cause a rotation of the driven member around the second rotation axis.

2. The antenna angle adjustment device according to claim 1, wherein the angle adjustment device is configured to adjust a polarization direction of a microwave antenna.

3. The antenna angle adjustment device according to claim 1, wherein the drive member has a supporting hole (6), the angle adjustment device includes a bolt (11), the bolt passes through the supporting hole, the driven member is rotatably supported on an unthreaded section of a shank of the bolt, and the bolt is configured to fasten the drive member.

4. The antenna angle adjustment device according to claim 1, wherein the first rotation axis and the second rotation axis are parallel to each other.

5. The antenna angle adjustment device according to claim 1, wherein the drive member has a finger-shaped part (5), and the finger-shaped part has an arcuate surface (15) which serves as the engagement point to be engaged with the curved portion.

6. The antenna angle adjustment device according to claim 1, wherein the drive member has a finger-shaped part (5), and the finger-shaped part has a roller (16) on its free end, the roller serving as the engagement point to be engaged with the curved portion.

7. The antenna angle adjustment device according to claim 5, wherein the finger-shaped part is formed axisymmetrically in a plane perpendicular to the first rotation axis.

8. The antenna angle adjustment device according to claim 1, wherein the drive member has a tool engagement point (7) configured to be joined with a tool for manipulating the drive member.

9. The antenna angle adjustment device according to claim 1, wherein the driven member has a flange plate (12) which has the curved portion.

10. The antenna angle adjustment device according to claim 1, wherein the curved portion is formed axisymmetrically in a plane perpendicular to the second rotation axis.

11. The antenna angle adjustment device according to claim 2, wherein the driven member is an OMT component of the microwave antenna, or a component kinematically coupled with an OMT component.

12. The antenna angle adjustment device according to claim 2, wherein the angle adjustment device is configured to finely adjust the polarization direction of the microwave antenna.

13. The antenna angle adjustment device according to claim 12, wherein the angle adjustment device is configured to finely adjust the polarization direction of the microwave antenna within a range of ±5°.

14. The antenna angle adjustment device according to claim 1, wherein the drive member and the driven member have a constant transmission ratio greater than 1.

15. The antenna angle adjustment device according to claim 14, wherein the drive member and the driven member have a constant transmission ratio greater than 3.

16. An antenna fitted with the antenna angle adjustment device according to claim 1.
